(19) United States
(12) Patent Application Publication
(10) Pub. No.: US 2006/0115638 A1
(43) Pub. Date: Jun. 1, 2006

(54) Ink package

(75) Inventor: Yukihiko Shibata, Aichi (JP)

Correspondence Address: Christopher J. Fildes;Fildes& Outland, P.C., Suite 2, 20916 Mack Avenue, Grosse Pointe Woods, MI, 48236, US

(73) Assignee: Daiwa Gravure Co., Ltd.

(21) Appl. No.: 11/208,914

(22) Filed: Aug. 22, 2005

(30) Foreign Application Priority Data
Nov. 30, 2004 (JP) 2004-345052

(51) Int. Cl. B32B 7/02

(52) U.S. Cl. 428/212

(57) ABSTRACT

An ink package that reliably prevents ink leakage from and infiltration of air or the like into the ink package at a piercing part to be pierced by an ink extracting member, and that allows ink to be taken out almost to the last even if the left in the ink package is only a small amount. The ink package is formed using a synthetic resin film and allows an ink extracting member to pierce thereinto, and includes an A layer of a laminate film including a stretched film and a non-stretched film layered on and adhered to the inner surface of the stretched film, and a B layer of a multilayer non-stretched film positioned on the inner side of the A layer. At least the A layer and the B layer are separable when the ink extracting member pierces the ink package at the piercing part.

### BACKGROUND OF THE INVENTION

1. Field of the Invention

The invention relates to an ink package of an ink cartridge set and used in a printer.

2. Description of the Related Art

Conventionally, as an ink package of an ink cartridge of this type, an ink package formed with a film of a layered structure is known, in which a plurality of film sheets made from polyethylene resin and the like are layered one over another as disclosed in for example, JP-A 11-99659 (1999). The ink package is configured so as to prevent ink leakage from the ink package or infiltration of air or the like into the ink package in a state where a needle-shaped ink extracting member is pierced into the ink package.

The ink package of the ink cartridge disclosed in JP-A 11-99659 (1999) is formed with a film of a layered structure in which a plurality of film sheets made from polyethylene resin and the like are layered one on top of the other. However, there is no disclosure about the type of the film used, that is, whether the film is a non-stretched film or a stretched film. Since it is difficult to use only the non-stretched film from the viewpoint of package strength, it can be conceived that a stretched film and a non-stretched film are layered one over the other to form a film for use. When a film for use is a layered structure type in which a stretched film and a non-stretched film are layered one on the other, the non-stretched film closely attaches to the ink extracting member at a piercing part to be pierced by the ink extracting member. Although the effects of preventing ink leakage and preventing air or the like from infiltrating into the ink package can be expected, the stretched film is easily ripped when pierced by the ink extracting member, and concomitantly, the non-stretched film adhered to the stretched film is also threatened to be ripped. This may cause a gap to be formed around the ink extracting member, whereby the non-stretched film does not closely attach to the ink extracting member.

### SUMMARY OF THE INVENTION

In order to solve the above-mentioned problem, it is an object of the invention to provide an ink package in which ink leakage or infiltration of air or the like into the ink package at a piercing part to be pierced by the ink extracting member is reliably prevented, and in which ink is taken out substantially to the last even when the left in the ink package is only a small amount.

Provided for achieving the object of the present invention is an ink package characterized as follows:

(1) An ink package formed with a synthetic resin film, and allowing an ink extracting member to pierce thereinto, the ink package comprising: an A layer of a laminate film including a stretched film and a non-stretched film layered on and adhered to an inner surface of the stretched film; and a B layer including a multilayer non-stretched film on an inner side of the A layer without being adhered thereto.

(2) An ink package formed with a synthetic resin film, and allowing an ink extracting member to pierce thereinto, the ink package comprising: an A layer of a laminate film including a stretched film and a non-stretched film layered on and adhered to an inner surface of the stretched film; and a B layer including a multilayer non-stretched film positioned on an inner side of the A layer, wherein the A layer and the B layer are joined using an adhesive applied to at least one of opposing faces of the non-stretched film of the A layer and the B layer, the adhesive being applied to other parts than a piercing part to be pierced by the ink extracting member.

(3) An ink package formed with a synthetic resin film, and allowing an ink extracting member to pierce thereinto, the ink package comprising: an A layer of laminate film including a stretched film and a non-stretched film layered on and adhered to an inner surface of the stretched film; and a B layer including a multilayer non-stretched film positioned on an inner side of the A layer, wherein an adhesion preventing layer is provided on at least one of opposing surfaces of the non-stretched film of the A layer and the B layer, at a piercing part to be pierced by the ink extracting member, and the A layer and the B layer are joined at other parts than the adhesion preventing layer.

According to the configurations described in the above-mentioned (1) to (3), the ink package comprises an A layer of a laminate film including a stretched film and a non-stretched film layered on and adhered to the inner surface of the stretched film, and a B layer including a multilayer non-stretched film positioned on the inner side of the A layer. The A layer and the B layer are separable by way of piercing the ink extracting member into the package at the piercing part. Even if the A layer of a laminate film including the stretched film and the non-stretched film layered on and adhered to the inner surface of the stretched film is ripped when the package is pierced by the ink extracting member at the piercing part, the B layer including the multilayer non-stretched polyethylene film will not be ripped. The B layer is closely attached to the ink extracting member, thereby reliably preventing ink leakage from or infiltration of air or the like into the ink package, and allowing the ink to be taken out substantially to the last even if the left in the ink package is only a small amount. Further, by joining the A layer and the B layer at positions other than the piercing part of the ink extracting member, slipping off between the A layer and the B layer does not occur, so that manufacturing is smoothly performed with enhanced manufacturing efficiency.

### BRIEF DESCRIPTION OF THE DRAWINGS

FIG. 1 is a perspective view of an ink package according to a first embodiment of the invention;

FIG. 2 is an enlarged cross sectional view of a sheet forming the ink package;

FIG. 3 is a development view of the ink package;

FIG. 4 is an enlarged cross sectional view showing a state where an ink extracting member has pierced into the ink package;

FIG. 5 is a perspective view of an ink package according to a second embodiment of the invention;

FIG. 6 is an enlarged cross sectional view of a sheet forming the ink package;

FIG. 7 is a development view of the ink package;

FIG. 8 is an enlarged cross sectional view showing a state where an ink extracting member has pierced into the ink package;

FIG. 9 is a development view of an ink package according to a third embodiment of the invention;

FIG. 10 is a perspective view of an ink package according to a fourth embodiment of the invention; and

FIG. 11 is an enlarged cross sectional view of the sheet forming the ink package.

### DESCRIPTION OF THE PREFERRED EMBODIMENTS

### First Embodiment

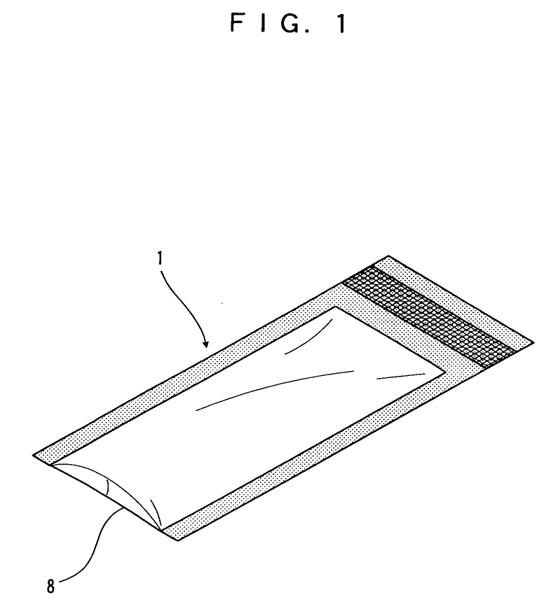

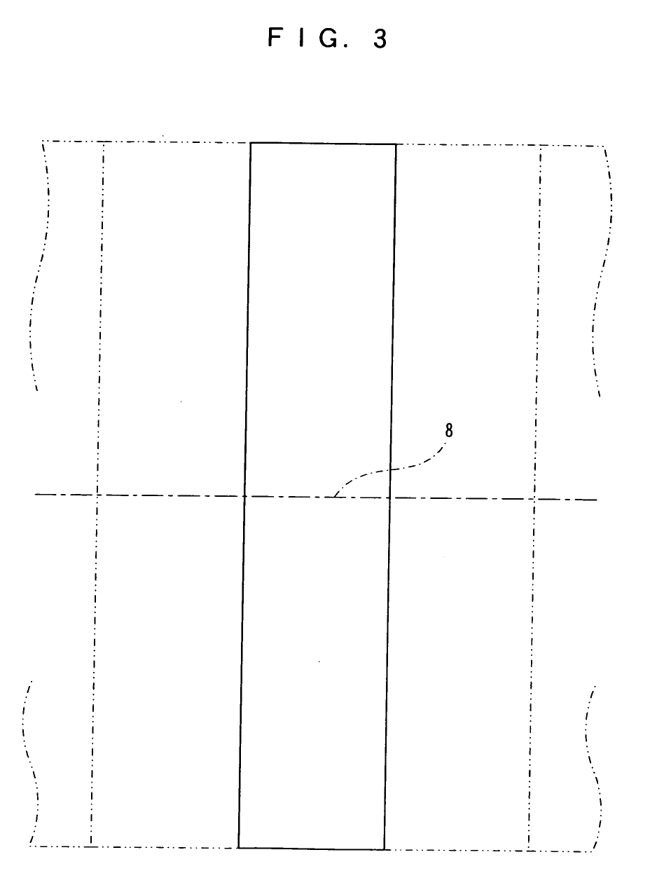

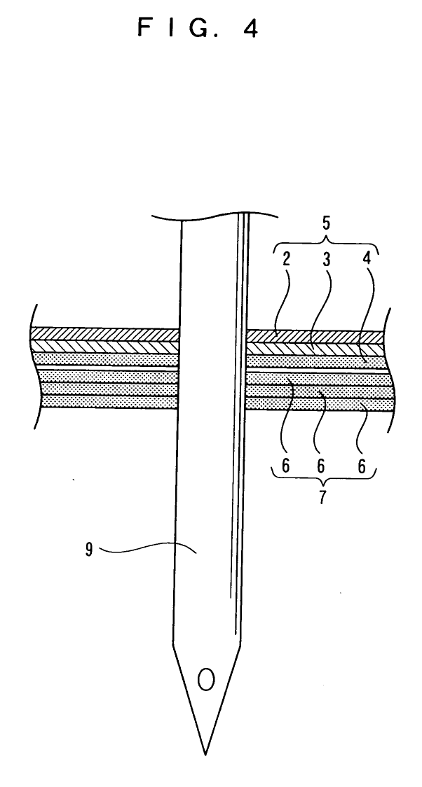

FIGS. 1 to 4 show a first embodiment of the invention.

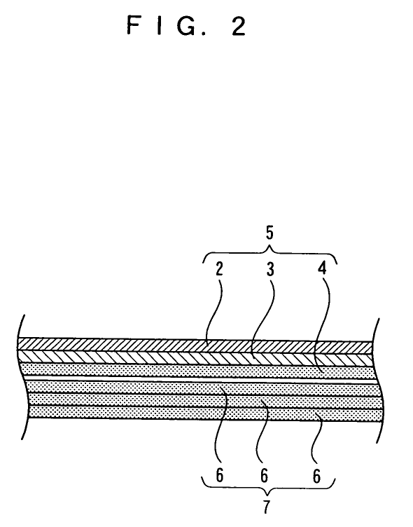

In FIGS. 1 to 4, the reference character 1 is an ink package containing ink, and the ink package 1 is formed by using an A layer 5 of a laminate film including a stretched polyethylene terephthalate film 2 on the outer most layer as shown in FIG. 2, an aluminum foil 3 serving as a gas or vapor barrier layer adhered onto the inner surface of the film 2, and a non-stretched polyethylene film 4 layered on and adhered to the inner surface of the foil 3, and a B layer 7 including a plurality of, more specifically, three layers of non-stretched polyethylene film 6 overlapping each other and positioned on the inner side of the A layer 5. The ink package 1 is formed by folding double, in the longitudinal direction, the sheet having the B layer 7 overlapping on the inner side of the A layer 5, and heat sealing the three sides excluding the one side that is the folded part 8. Particularly, a tubular body is formed by heat sealing the one side opposed to the side of the folded part 8 of the folded sheet, and ink is filled into the tubular body. Then, the tubular body is divided while being applied with heat sealing at equal intervals. The ink package 1 filled with ink is thus produced.

The folded part 8 becomes a piercing part to be pierced by a needle-shaped ink extracting member 9. In order to facilitate the piecing by the ink extracting member 9, the folded part 8 is formed flat by being pressed inwardly of the ink package 1.

In a state where the ink package 1 is set in a printer, the needle-shaped ink extracting member 9 is caused to pierce the flat folded part 8 of the ink package 1 to extract the ink contained in the ink package 1. The part of the ink package 1 that is to be pierced by the ink extracting member 9 is formed by a sheet material comprised of the A layer 5 of a laminate film including the stretched polyethylene terephthalate film 2 on the outer most layer, the aluminum foil 3 layered on and adhered to the inner surface of the film 2, and the non-stretched polyethylene film 4 layered on and adhered to the inner surface of the foil 3, and the B layer 7 including three-layered non-stretched polyethylene film 6 overlapping on the inner side of the A layer 5. The A layer 5 and the B layer 7 are separate from each other without being joined together. Thereby, even if the A layer 5 is ripped when the ink extracting member 9 pierces the piercing part, the B layer 7 comprised only of a single film of the three-layered non-stretched polyethylene film 6 does not rip, and keeps closely attaching to the ink extracting member 9. Thus, there arises no problem of liquid leakage or infiltration of air.

### Second Embodiment

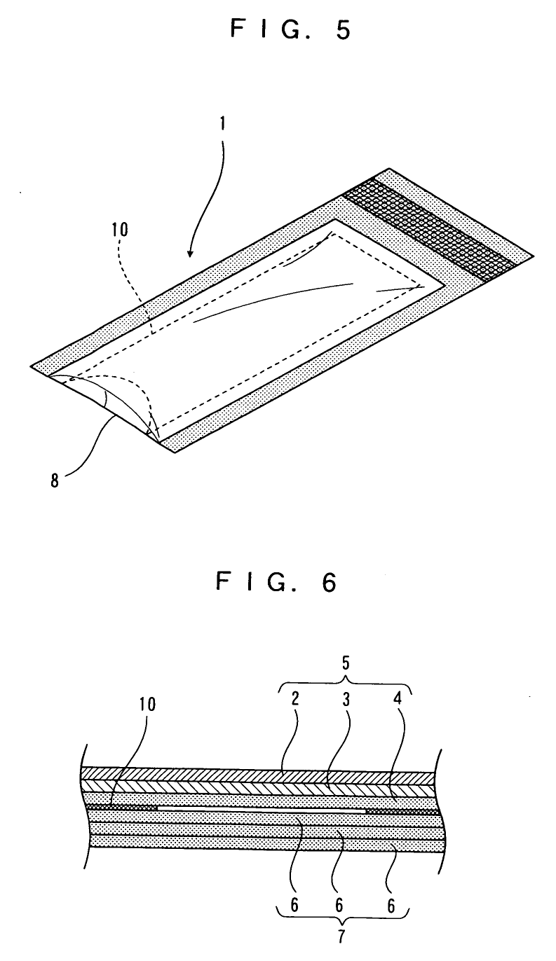

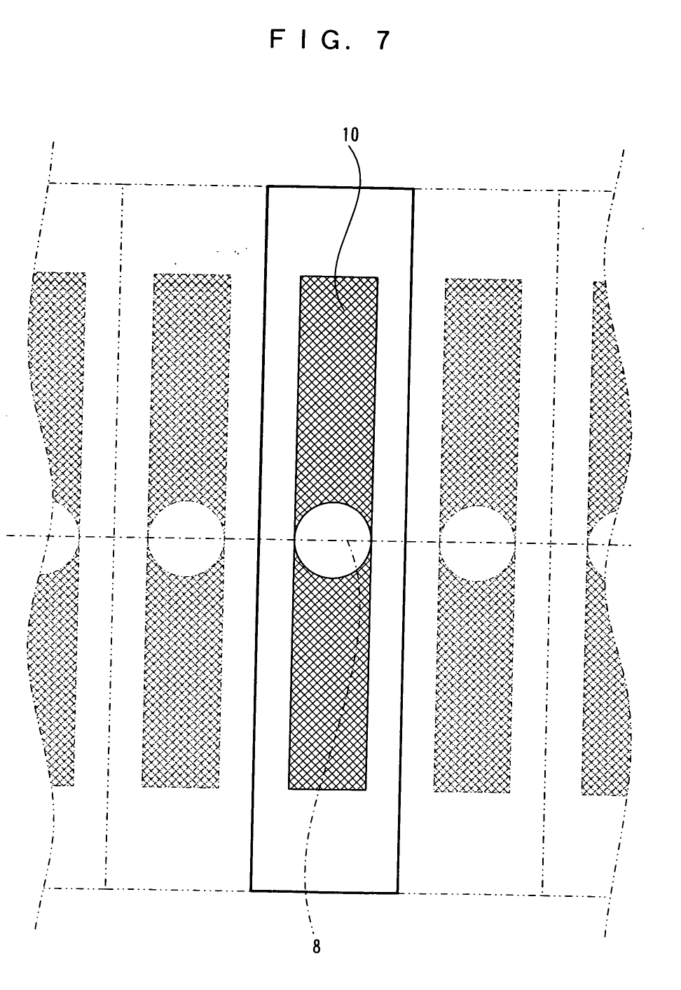

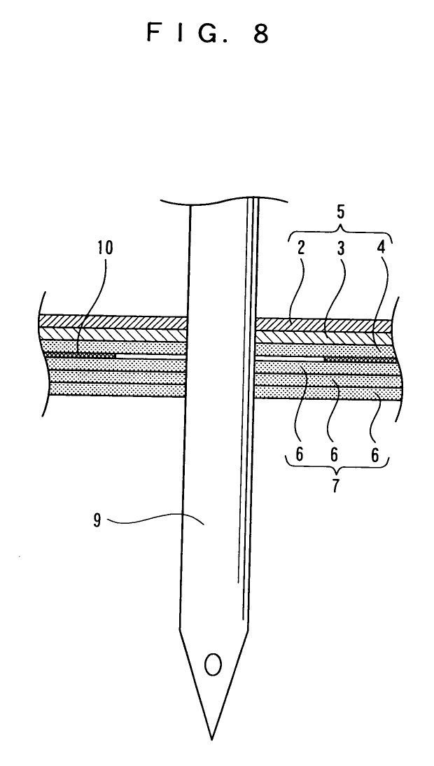

FIGS. 5 to 8 show a second embodiment of the invention.

In the second embodiment shown in FIGS. 5 to 8, in addition to the configuration of the first embodiment, a pressure sensitive adhesive (so-called adhesive), more specifically a cold sealing agent 10, is applied to the non-stretched polyethylene film 4 of the A layer 5 on the opposing surface to the B layer 7, by means of gravure printing. The A layer 5 and the B layer 7 are then joined by a heat roller at 20° C. to 80° C. with a force that is just sufficient to prevent natural separation at a portion where the cold sealing agent 10 has been provided. The range of applying the cold sealing agent 10 is set to exclude a peripheral portion of the ink package 1 other than the folded part 8, which peripheral portion is to be fusion joined by heat sealing, and the piercing part to be pierced by the ink extracting member 9.

Thus, the A layer 5 and the B layer 7 are joined by the heat roller at 20° C. to 80° C. using the cold sealing agent 10 applied in a range including the peripheral part fusion joined by heal sealing and the piercing part to be pierced by the ink extracting member 9, so that no slipping off occurs between the A layer 5 and the B layer 7. Accordingly, the manufacturing is smoothly performed with enhanced manufacturing efficiency.

By forming an infinite number of small bumps on the surface of the non-stretched polyethylene film 4 of the A layer 5 and/or the surface of the B layer 7, which surfaces of the A layer 5 and the B layer 7 are opposed to each other at the piercing part to be pierced by the ink extracting member 9, the A layer 5 and the B layer 7 are reliably prevented from closely attaching to each other.

### Third Embodiment

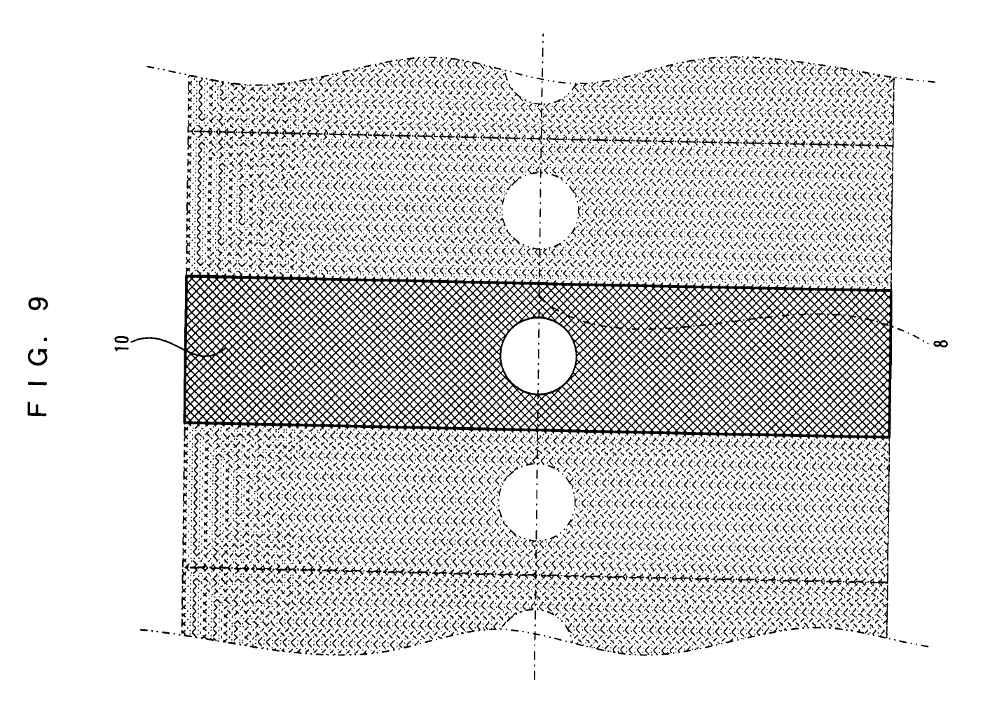

FIG. 9 shows a third embodiment of the invention.

In the second embodiment, the A layer 5 and the B layer 7 are joined using the cold sealing agent 10 applied to such a range that is set to exclude a peripheral portion of the ink package 1 other than the folded part 8, which peripheral portion is to be fusion joined by heat sealing, and the piercing part to be pierced by the ink extracting member 9. In the third embodiment, the A layer 5 and the B layer 7 are joined using the cold sealing agent 10 applied over the entire surface excluding the piercing part to be pierced by the ink extracting member 9. In like manner as in the second embodiment, the cold sealing agent 10 is applied on the side of the non-stretched polyethylene film 4 of the A layer 5. In the third embodiment, when the peripheral three sides excluding the folded part 8 of the ink package 1 are jointed by heat sealing, the cold sealing agent 10 is present in such area to be heat sealed. As a result of an experiment, it was found that under the conditions of usual handling and usage, no leakage of ink from the inside of the heat sealed part or separation between the A layer and the B layer occurs, showing there is no problem. Incidentally, if the cold sealing agent 10 is used over the entire opposing surfaces of the A layer 5 and the B layer 7 excluding the piercing part to be pierced by the ink extracting member 9 as in the third embodiment, the amount of the cold sealing agent 10 used increases, thereby increasing the cost. In such case, the cold sealing agent 10 may be applied linearly or in spots on the side of the non-stretched polyethylene film 4 of the A layer 5 within the range excluding the piercing part to be pierced by the ink extracting member 9.

The cold sealing agent 10 used as the adhesive is applied on the side of the A layer 5 in the second and third embodiments, but it may be applied on the side of the B layer 7, or on both sides of the A layer 5 and the B layer 7.

### Fourth Embodiment

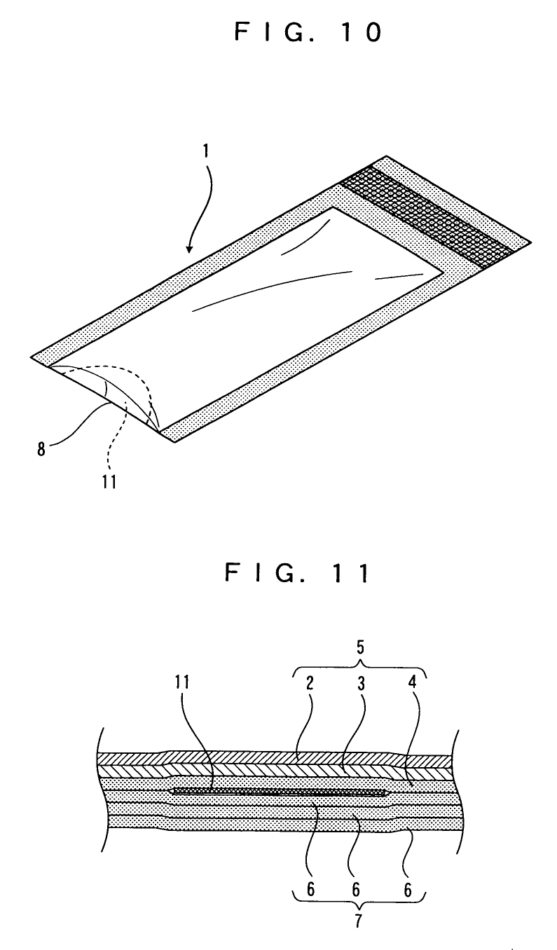

FIGS. 10 and 11 show a fourth embodiment of the invention.

In order to prevent misalignment between the A layer 5 and the B layer 7 during manufacturing, in the fourth embodiment, an adhesion preventing layer 11 is provided, by means of gravure printing, on the side of the non-stretched polyethylene film 4 of the A layer 5 on the opposing surface to the B layer 7, at a position of the piercing part to be pierced by the ink extracting member 9. Then, the A layer 5 and the B layer 7 are joined at other area than the adhesion preventing layer 11, at about 80° C. to 120° C. with a force that is just or more than sufficient to prevent natural separation between the layers. As the adhesion preventing layer 11, a separation material made from a blend of polyamide and cellulose nitrate, a resin of a different type from that of the non-stretched polyethylene film forming the overlapping surfaces of the A layer 5 and the B layer 7, or the like may be used.

In the fourth embodiment, the adhesion preventing layer 11 is provided on the side of the A layer 5 side, but it may be provided on the side of the B layer 7, or otherwise on both sides of the A layer 5 and the B layer 7.

Four embodiments have been explained above, but the configuration of the layered sheet used as the material to form the ink package 1 is not limited to the aforementioned. Further, as the barrier layer, in addition to the rolled film such as aluminum foil 5 mentioned above, a deposition film made by depositing aluminum, silica, alumina or the like on the film, a film of ethylene-vinyl alcohol copolymer, or polychlorinated vinylidene may be used. Further, as far as the inner most layer of the A layer 5 is made from the non-stretched polyethylene film 4, rayon, paper or the like may be interposed midway between the film layers.

Moreover, the form of the ink package 1 is not limited to those shown in the aforementioned embodiments.

What is claimed is:

1. An ink package formed with a synthetic resin film, and allowing an ink extracting member to pierce thereinto, the ink package comprising:
an A layer of a laminate film including a stretched film and a non-stretched film layered on and adhered to an inner surface of the stretched film; and
a B layer including a multilayer non-stretched film positioned on an inner side of the A layer without being adhered thereto.

2. An ink package formed with a synthetic resin film and allowing an ink extracting member to pierce thereinto, the ink package comprising:
an A layer of a laminate film including a stretched film and a non-stretched film layered on and adhered to an inner surface of the stretched film; and
a B layer including a multilayer non-stretched film positioned on an inner side of the A layer, wherein
the A layer and the B layer are joined using an adhesive applied to at least one of opposing surfaces of the non-stretched film of the A layer and the B layer, the adhesive being applied to other parts than a piercing part to be pierced by the ink extracting member.

3. An ink package formed with a synthetic resin film, and allowing an ink extracting member to pierce thereinto, the ink package comprising:
an A layer of a laminate film including a stretched film and a non-stretched film layered on and adhered to an inner surface of the stretched film; and
a B layer including a multilayer non-stretched film positioned on an inner side of the A layer, wherein
an adhesion preventing layer is provided on at least one of opposing surfaces of the non-stretched film of the A layer and the B layer, at a piercing part to be pierced by the ink extracting member, and the A layer and the B layer are joined at other parts than the adhesion preventing layer.
